(19) United States
(12) Patent Application Publication
(10) Pub. No.: US 2011/0058002 A1
(43) Pub. Date: Mar. 10, 2011

(54) PRINTING METHOD

(75) Inventors: Yuki MORIYA, Shiojiri-shi (JP); Yoshitaka SHIMADA, Matsumoto-shi (JP)

(73) Assignee: SEIKO EPSON CORPORATION, Tokyo (JP)

(21) Appl. No.: 12/872,615

(22) Filed: Aug. 31, 2010

(30) Foreign Application Priority Data
Sep. 4, 2009 (JP) 2009-204442

(51) Int. Cl. B41J 2/01

(52) U.S. Cl. 347/104

(57) ABSTRACT

A printing method includes: performing a printing process while transporting a recording medium in a transport direction; and pinching the recording medium between a first roller and a second roller while transporting the recording medium by the second roller, by making the first roller that moves in the transport direction and the second roller that transports the recording medium in the transport direction come close to each other.

### BACKGROUND

1. Technical Field

The present invention relates to a printing method.

2. Related Art

Heretofore, there is known a printing apparatus provided with a paper discharge roller and a knurled roller, which are disposed on the downstream side of a recording section that performs a printing process, thereby pinching and discharging a recording medium (refer to JP-A-2005-169749, for example). In the case of printing a character or an image on the recording medium by using such a printing apparatus, a method is known in which at the normal time, the paper discharge roller and the knurled roller remain spaced from each other, and as necessary, the knurled roller comes close to the paper discharge roller, thereby pinching the recording medium therebetween.

However, in a printing method in the past, the knurled roller has a velocity component in the transport direction of the recording medium when coming close to the recording medium. Also, when the recording medium comes into contact with the knurled roller, the transport of the recording medium in the transport direction is stopped. Therefore, there is a problem in which not only press marks are formed on the recording medium due to the fact that the knurled roller collides with and bites into the recording medium when pinching the recording medium, but also the press mark is formed over the wide range of the recording medium due to the fact that the knurled roller rotates in the state where the roller is breaking into the recording medium.

### SUMMARY

An advantage of some aspects of the invention is that it provides a printing method in which it is possible to decrease the range of a press mark which is formed on a recording medium.

According to an aspect of the invention, there is provided a printing method including: performing a printing process while transporting a recording medium in a transport direction; and pinching the recording medium between a first roller and a second roller while transporting the recording medium by the second roller, by making the first roller that moves in the transport direction and the second roller that transports the recording medium in the transport direction come close to each other.

By performing printing in this manner, when pinching the recording medium in a step of the pinching, the first roller collides with and bites into the recording medium, so that a press mark is formed on the recording medium. Since the first roller moves also in the transport direction of the recording medium when coming close to the recording medium, the first roller has a velocity component in the transport direction of the recording medium. However, in the invention, since, when pinching the recording medium, the recording medium is transported in the transport direction, the relative velocity of the first roller to the recording medium in the transport direction of the recording medium is decreased. Therefore, according to the invention, the range in which the first roller rotates in a state where the roller collides with and bites into the recording medium is decreased, so that the range of the press mark which is formed on the recording medium can be decreased.

Also, in the printing method according to the invention, a movement velocity in the transport direction of the first roller is made to coincide with a transport velocity in the transport direction of the recording medium.

By performing printing in this manner, when the first roller comes into contact with the recording medium, a state is made where the first roller is stationary with respect to the recording medium in the transport direction of the recording medium. Therefore, the first roller does not rotate in a state where the roller bites into the recording medium. Therefore, the range of the press mark which is formed on the recording medium can be minimized.

Also, in the printing method according to the invention, the first roller is moved along a circumference.

By performing printing in this manner, the first roller comes close to the second roller while moving in the transport direction of the recording medium, whereby the recording medium is pinched between the first roller and the second roller.

Also, in the printing method according to the invention, the first roller is a knurled roller which has plurality of protrusions on the outer circumference thereof, and the second roller is a paper discharge roller which discharges the recording medium after the printing process.

By performing printing in this manner, the range of the press mark by the knurled roller, which is easily noticeable, thereby greatly influencing the quality of the recording medium after the printing, is decreased, so that the quality of the recording medium after the printing can be improved.

### BRIEF DESCRIPTION OF THE DRAWINGS

The invention will be described with reference to the accompanying drawings, wherein like numbers reference like elements.

FIG. 1 is a perspective view of an ink jet printer in an embodiment of the invention.

FIG. 2 is a cross-sectional view showing a schematic configuration of the ink jet printer of FIG. 1.

FIGS. 3A and 3B are perspective views showing a driving mechanism of a paper discharge roller and a knurled roller of FIG. 2.

FIGS. 4A to 4C are process diagrams of a pinching process in a printing method of the embodiment.

FIGS. 5A to 5C are process diagrams of a pinching process in a previous printing method.

### DESCRIPTION OF EXEMPLARY EMBODIMENTS

Hereinafter, an embodiment of the invention will be described with reference to the drawings.

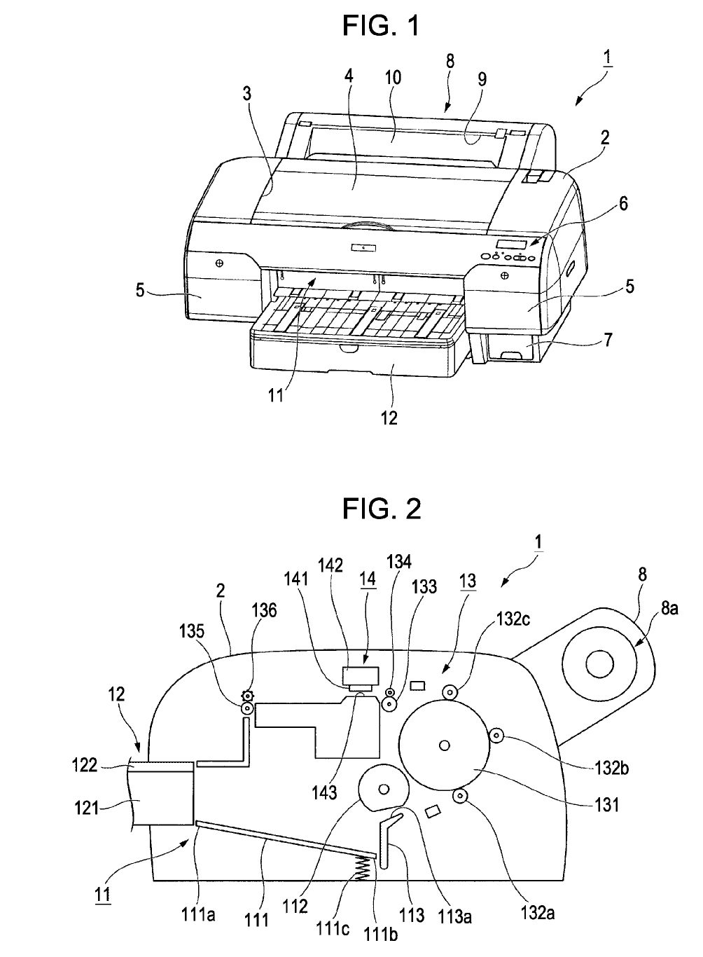

FIG. 1 is a perspective view of an ink jet printer (a printing apparatus) 1 of this embodiment.

The ink jet printer 1 shown in FIG. 1 is a desktop type large-sized printer which prints an image or a character onto, for example, a cut sheet having a relatively large paper size on the order of the JIS standard A4 size to an A2 size, or a recording paper (a recording medium) such as a rolled paper in which a recording paper is wound in a roll form.

The ink jet printer 1 is provided with a housing 2 which is a casing that covers an internal structure. A window portion 3 is provided in the upper surface of the housing 2. The window portion 3 is an opening portion for performing the maintenance of an internal mechanism of the ink jet printer 1 and is covered by a window cover 4 capable of being opened and closed. Cartridge receiving sections 5 and 5 are provided on both sides of the front face of the housing 2. The cartridge receiving section 5 accommodates a plurality of ink cartridges in the inside thereof. The cartridge receiving section 5 is provided so as to be able to be opened and closed, and made so as to be able to individually exchange the ink cartridges in the inside.

An operating section 6 is provided at a right upper portion of the front face of the housing 2. At the operating section 6, a power button which is used for on/off of an electric power supply, various operating buttons for performing document feeding or discharging of paper, flushing of ink, and the like, a display portion which displays the state of the ink jet printer 1, and so on are provided. A tank receiving section 7 is provided at a right lower portion of the front face of the housing 2. A waste liquid tank which receives waste ink that that is discarded at the time of a droplet discharge head cleaning process or when exchanging the ink cartridge is accommodated in the inside of the tank receiving section 7. The tank receiving section 7 is provided so as to be able to be opened and closed, and made so as to be able to clean the inside of the waste liquid tank.

A paper feed section 8 is provided at an upper portion of the rear face of the housing 2. The paper feed section 8 is provided so as to protrude to the upper rear side of the housing 2 and provided with a rolled paper holder 8a (refer to FIG. 2) which supports the rolled paper in the inside so as to be able to rotate. A paper feed window 9 covered by a cover 10 is provided on the front face side of the paper feed section 8. The cover 10 is provided so as to be able to be opened and closed, and made so as to mount or remove the rolled paper on or from the rolled paper holder 8a in the inside of the paper feed section 8 through the paper feed window 9 by opening the cover 10. The front face of the paper feed section 8 and the cover 10 serve as paper feed guide surfaces which guide the paper when manually feeding the cut sheet.

A paper feed and discharge section 11 is provided at the center of the lower portion of the front face of the housing 2. A paper feed and discharge tray 12 is detachably mounted on the paper feed and discharge section 11. Also, the paper feed and discharge section 11 is made so as to be able to manually feed a thick cut sheet which cannot be bent at the time of the paper feeding.

The paper feed and discharge tray 12 is provided so as to protrude ahead of the paper feed and discharge section 11 and made so as to be able to accommodate the stacked non-printed cut sheets in the inside and also place a printed cut sheet or rolled paper on the upper surface.

FIG. 2 is a cross-sectional view showing a schematic configuration of the inside of the ink jet printer 1.

As shown in FIG. 2, the ink jet printer 1 has the paper feed and discharge section 11, a transport section 13, and a printing section 14.

The paper feed and discharge section 11 is provided with a hopper 111 for replenishing the cut sheet, a paper feed roller 112 which feeds the cut sheet, a separating member 113 which separates overlapped cut sheets, and so on.

The hopper 111 is provided in a flat plate shape in which one end side 111a is located in the vicinity of a paper feed tray 121 of the lower portion of the paper feed and discharge tray 12 and on which the cut sheet fed from the paper feed tray 121 can be placed. The other end side 111b of the hopper 111 is located in the vicinity of the separating member 113 and the paper feed roller 112 and is provided to be able to swing with one end side 111a as a fulcrum so as to come close to and be spaced from the paper feed roller 112. Also, the other end side 111b of the hopper 111 is biased in the direction which comes close to the paper feed roller 112 by an elastic member such as a compression spring 111c, for example.

The paper feed roller 112 is formed onto a D-shape in a cross-section view, which has a planar surface at a portion of a cylindrical surface, and made so as to rotate, thereby allowing the cut sheet disposed on the hopper 111 to be intermittently transported by friction.

On the upper surface of the separating member 113, a high-friction surface 113a which holds the cut sheet by friction is formed. The separating member 113 is made so as to perform separation in such a manner that in a case where plural sheets of cut sheets are sent by the paper feed roller 112 in a state where they are stacked one above the other, only an upper side cut sheet is fed while a lower side cut sheets are held on the high-friction surface 113a.

The transfer section 13 is provided with a sub-roller 131 which transports the recording paper, driven rollers 132a, 132b, and 132c, a transport roller 133, a driven roller 134, a paper discharge roller (a second roller) 135, a knurled roller (a first roller) 136, a detection sensor which detects the recording paper, and so on.

The sub-roller 131 is made so as to pinch the cut sheet fed by the paper feed roller 112, between the sub-roller and a plurality of driven rollers 132a, 132b, and 132c and transport the cut sheet along a rotational direction by friction, thereby feeding the sheet to the transport roller 133. Also, in the case of performing printing by using the rolled paper, the sub-roller 131 is made so as to pinch the rolled paper which is fed from the paper feed section 8, between the sub-roller and the driven roller 132c, thereby feeding the paper to the transport roller 133.

The transport roller 133 is made so as to rotate while pinching the cut sheet or the rolled paper fed by the sub-roller 131, between the transport roller and the driven roller 134, thereby feeding such a recording paper to the printing section 14.

The paper discharge roller 135 is made so as to rotate while pinching the recording paper fed by the transport roller 133 and then passed through the printing section 14, between the paper discharge roller and the knurled roller 136, thereby discharging the recording paper to a paper discharge tray 122 of the upper portion of the paper feed and discharge tray 12. The knurled roller 136 has a plurality of protrusions on the outer circumference thereof.

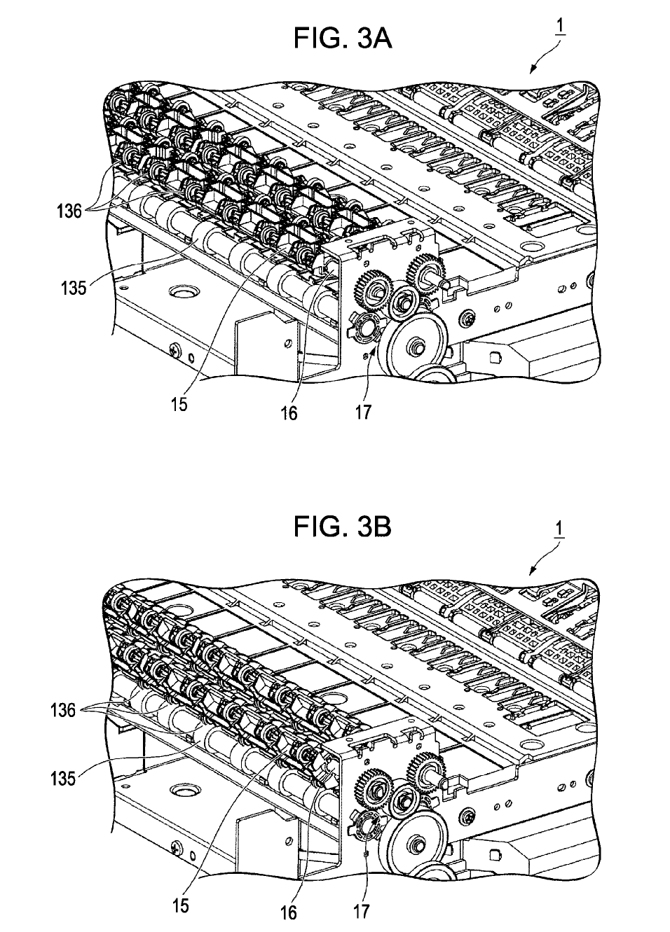

FIGS. 3A and 3B are perspective views showing a driving mechanism of the paper discharge roller 135 and the knurled roller 136.

As shown in FIG. 3A, the ink jet printer 1 is provided with a holder 15 which holds a plurality of knurled rollers 136, a rotary shaft 16 to which the holder 15 is fixed, and a gear section 17 which is driven by a motor (not shown), thereby rotating the rotary shaft 16 by a given angle. In FIG. 3A, the knurled roller 136 and the paper discharge roller 135 are in a state where they are spaced from each other.

If the rotary shaft 16 rotates in the counterclockwise direction in FIG. 3A, the holder 15 is made so as to rotate integrally with the rotary shaft 16, as shown in FIG. 3B.

Also, if the rotary shaft 16 rotates in the counterclockwise direction in FIG. 3A, the knurled roller 136 moves along a circumference with the rotary shaft 16 as the center in accordance with the rotation of the holder 15. Then, the knurled roller is made to come close to the paper discharge roller 135, thereby being able to pinch the recording paper between the knurled roller and the paper discharge roller 135, as shown in FIG. 3B.

As shown in FIG. 2, the printing section 14 is provided with a droplet discharge head 141 which discharges ink droplets, a carriage 142 which holds the droplet discharge head 141, a platen 143 which supports the recording paper, and so on.

The droplet discharge head 141 is provided corresponding to ink of each color which is supplied from the ink cartridge, and made so as to be able to discharge ink droplets from a plurality nozzles (not shown).

The carriage 142 is made so as to be able to reciprocate by a driving device (not shown) in the state of holding a plurality of droplet discharge heads 141 corresponding to ink of the respective colors.

A printing method of printing a character or an image onto the recording paper by using the ink jet printer 1 having the above configuration will be described.

As shown in FIG. 2, if the paper feed and discharge tray 12 is mounted on the paper feed and discharge section 11, a bundle of cut sheets accommodated in the paper feed tray 121 of lower portion of the paper feed and discharge tray 12 is disposed on the hopper 111. In the case of performing printing on the cut sheet, if the printing is carried out, the paper feed roller 112 rotates. Then, the uppermost cut sheet is separated from the bundle of cut sheets on the hopper 111 by the friction by the paper feed roller 112 and the friction of the separating member 113, thereby being fed between the sub-roller 131 and the driven roller 132a.

The cut sheet fed between the sub-roller 131 and the driven roller 132a is pinched by the sub-roller 131 and a plurality of driven roller 132a, 132b, and 132c disposed in the circumferential direction of the sub-roller and transported so as to turn on to the front face side of the ink jet printer 1 along the rotational direction of the sub-roller 131 by the rotation of the sub-roller 131. The cut sheet transported to the front face side of the ink jet printer 1 by the sub-roller 131 is fed between the transport roller 133 and the driven roller 134.

In the case of performing printing on the rolled paper, if the printing is carried out, the leading end of the rolled paper set on the rolled paper holder 8a of the paper feed section 8 and pinched between the sub-roller 131 and the driven roller 132c is fed between the transport roller 133 and the driven roller 134 by the rotation of the sub-roller 131.

A control section of the ink jet printer 1 executes a printing process if the recording paper such as the cut sheet or the rolled paper transported by the rotation of the transport roller 133 reaches a given position on the platen 143. Specifically, the control section moves the carriage 142, thereby moving the droplet discharge head 141 to a given position, and then discharges a droplet of each color of ink from the nozzle of the droplet discharge head 141. Then, by landing the ink droplet at a given position on the recording paper while moving the recording paper by a given feed amount by the transport roller 133, a printing process which prints a character or an image is carried out.

The recording paper transported in a transport direction by the transport roller 133 and then subjected to the printing process reaches between the paper discharge roller 135 and the knurled roller 136. At this time, the paper discharge roller 135 and the knurled roller 136 are in a state where they are spaced from each other, as shown in FIG. 3A. The control section of the ink jet printer 1 executes a pinching process which makes the knurled roller 136 and the paper discharge roller 135 come close to each other, thereby pinching the recording paper between these rollers, at a given timing.

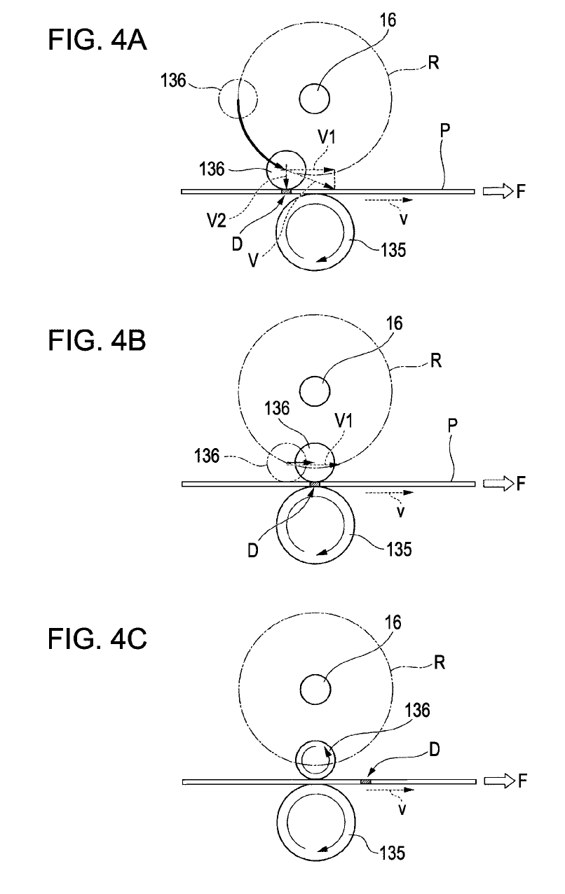

FIGS. 4A to 4C are process diagrams of the pinching process of this embodiment.

In the pinching process, the control section of the ink jet printer 1 drives the gear section 17 shown in FIG. 3A, thereby rotating the rotary shaft 16. Also, the control section rotates the paper discharge roller 135, thereby transporting a recording paper P in a transport direction F.

Then, as shown in FIG. 4A, the knurled roller 136 moves along a circumference R with the rotary shaft 16 as the center from a position spaced from the paper discharge roller 135, comes close to the paper discharge roller 135 while moving in the transport direction F of the recording paper P, and then comes into contact with the recording paper P.

At this time, the knurled roller 136 has a movement velocity V in a tangential direction of the circumference R and a movement velocity V1 in the transport direction F of the recording paper P. Also, the knurled roller 136 has a movement velocity V2 in the direction vertical to the transport direction F when coming into contact with the recording paper P. Therefore, the knurled roller 136 collides with the recording paper P, so that the protrusion of the knurled roller 136 bites into the recording paper P, whereby a press mark D is formed.

Here, the control section of the ink jet printer 1 adjusts the rotating velocities of the transport roller 133 and the paper discharge roller 135 such that a transport velocity v in the transport direction F of the recording paper P and the movement velocity V1 in the transport direction F of the knurled roller 136 coincide with each other, at the time of the contact of the knurled roller 136 with the recording paper P. Specifically, the control section adjusts the movement velocity V1 in the transport direction F of the knurled roller 136 with respect to the transport velocity v in the transport direction F of the recording paper P by the transport roller 133, thereby making the velocities coincide with each other.

The knurled roller 136 tries to further move along the circumference R after coming into contact with the recording paper P. However, the knurled roller 136 is provided so as to be biased outward in the radial direction of the circumference R by a biasing member (not shown) such as a spring, thereby being able to be displaced inward in the radial direction of the circumference R.

Therefore, as shown in FIG. 4B, after coming into contact with the recording paper P, the knurled roller 136 is displaced inward in the radial direction of the circumference R by receiving a reactive force from the recording paper P and moves along the transport direction F at nearly the movement velocity V1.

At this time, the movement velocity V1 of the knurled roller 136 is adjusted so as to become equal to the transport velocity v in the transport direction F of the recording paper P. Therefore, the knurled roller 136 is in a state where the roller is stationary with respect to the recording paper P in the transport direction F. Thus, after coming into contact with the recording paper P, the knurled roller 136 moves on the paper discharge roller 135 without rotating, so that a state is made where the recording paper P is pinched between the knurled roller 136 and the paper discharge roller 135.

Thereafter, as shown in FIG. 4C, the recording paper P is pinched between the knurled roller 136 and the paper discharge roller 135 and transported in the transport direction F by the rotation of the paper discharge roller 135, thereby being discharged to the paper discharge tray 122 of the upper portion of the paper feed and discharge tray 12 shown in FIG. 2. By the movement of the recording paper P in the transport direction F, the knurled roller 136 is rotated in a state where the recording paper P is pinched between the knurled roller and the paper discharge roller 135.

As described above, in the printing method of this embodiment, at the time of the discharging of the recording paper P, the pinching is performed by making the knurled roller 136 come close to the paper discharge roller 135 while moving the knurled roller in the transport direction F, and at that time, the recording paper P is transported in the transport direction F at the transport velocity v.

Therefore, compared to the case of making the recording paper P be stationary at the time of the contact of the knurled roller 136, as in the past, the relative velocity of the knurled roller 136 in the transport direction F of the recording paper P to the recording paper P is decreased from V1 to V1-v. Accordingly, a range in which the knurled roller 136 rotates in a state where the knurled roller bites into the recording paper P after coming into contact with the recording paper P is decreased, so that it is possible to decrease the range of the press mark D which is formed on the recording paper P.

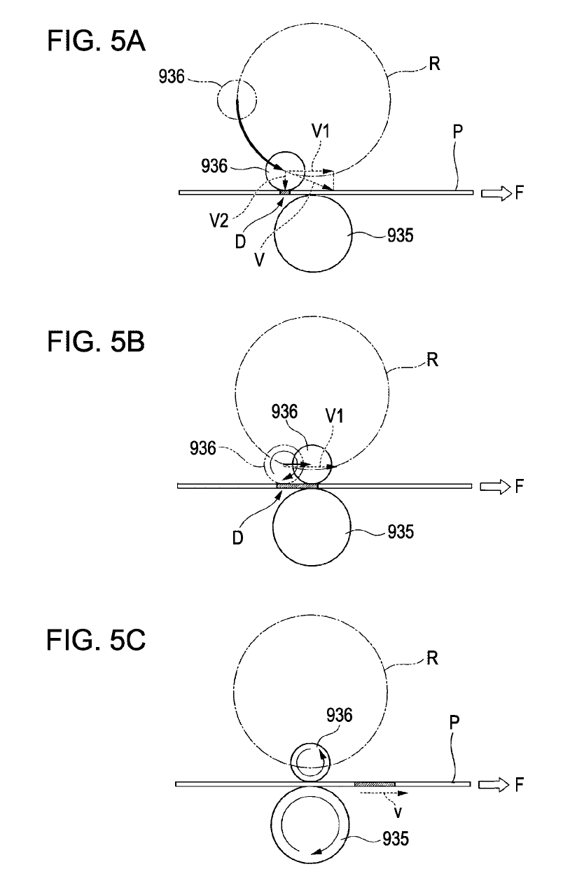

FIGS. 5A to 5C are process diagrams of a pinching process in a printing method in the past.

As shown in FIG. 5A, in the pinching process in the past, when pinching the recording paper P by moving a knurled roller 936 along the circumference R, thereby coming close to a paper discharge roller 935, the recording paper P is made stationary by stopping the transport of the recording paper P.

Also in this case, the knurled roller 936 has the movement velocity V2 in the direction vertical to the transport direction F when coming into contact with the recording paper P. Therefore, the knurled roller 936 collides with the recording paper p, so that the protrusion of the knurled roller 936 bites into the recording paper P, whereby the press mark D is formed.

At this time, the recording paper P is in a stationary state, and the knurled roller 936 has the movement velocity V1 in the transport direction F of the recording paper P. Therefore, as shown in FIG. 5B, the knurled roller 936 moves along the transport direction F at nearly the movement velocity V1 while rotating on the recording paper P, in a state where the knurled roller collides with and bites into the recording paper P. By this, the press mark D due to the knurled roller 936 is extensively formed on the recording paper P.

Thereafter, as shown in FIG. 5C, the recording paper P is transported at the transport velocity v in the transport direction F by the rotation of the paper discharge roller 935, and in accordance with this, the knurled roller 936 also rotates.

The press mark D which is formed when the knurled roller 936 collides with the recording paper P is relatively easily noticeable and greatly influences the quality of the recording paper after the printing. In the printing method in the past, the press mark D is formed over a wide range of the recording paper P, so that the quality of the recording paper after the printing is degraded.

On the contrary, according to the printing method of this embodiment shown FIGS. 4A to 4C, compared to the printing method in the past shown FIGS. 5A to 5C, the relative velocity of the knurled roller 136 to the recording paper P is decreased, so that it is possible to decrease the range of the press mark D which is formed on the recording paper P.

In addition, in this embodiment, as shown in FIG. 4A, at the time of the contact of the knurled roller 136 with the recording paper P, the movement velocity V1 of the knurled roller 136 in the transport direction F of the recording paper P is made to coincide with the transport velocity v of the recording paper P. Then, when the knurled roller 136 comes into contact with the recording paper P, a state is created where the knurled roller 136 is stationary with respect to the recording paper P in the transport direction F of the recording paper P. Therefore, the knurled roller 136 does not rotate in a state where the knurled roller bites into the recording paper P. Using this, the range in which the press mark D is formed on the recording paper P can be limited only to a place where the knurled roller 136 first comes into contact. Accordingly, the range over which the press mark D is formed can be minimized.

Also, by moving the knurled roller 136 along the circumference R, it is possible to make the knurled roller 136 come close to the paper discharge roller 135 while moving the knurled roller in the transport direction F of the recording paper P, and thus pinch the recording paper P between the knurled roller 136 and the paper discharge roller. Therefore, compared to the case of pinching the recording paper P between the knurled roller and the paper discharge roller 135 by moving the knurled roller 136 vertically to the transport direction F of the recording paper P, the impact of the knurled roller 136 which collides with the recording paper p is alleviated, so that it is possible to make formation of the press mark D difficult.

Also, in the pinching process, since it is not necessary to stop the transport of the recording paper P as in the past, a throughput at the time of the printing of the recording paper P can be improved.

In addition, the invention is not to be limited to the above-described embodiment, but various modifications can be made within the scope which does not depart from the purpose of the invention. For example, the invention can also be applied to rollers other than the knurled roller or the paper discharge roller. A mechanism which makes the first roller come close to the second roller may also be a pendulum-like structure. Also, parallelogram-shaped structure may also be used. Through this, it is possible to make the first roller come close to the recording medium while moving the first roller in the transport direction of the recording medium.

What is claimed is:

1. A printing method comprising:
performing a printing process while transporting a recording medium in a transport direction; and
pinching the recording medium between a first roller and a second roller while transporting the recording medium by the second roller, by making the first roller that moves in the transport direction and the second roller that transports the recording medium in the transport direction come close to each other.

2. The printing method according to claim 1, wherein the movement velocity in the transport direction of the first roller is made to coincide with the transport velocity in the transport direction of the recording medium.

3. The printing method according to claim 1, wherein the first roller is moved along the circumference.

4. The printing method according to claim 1, wherein the first roller is a knurled roller which has plurality of protrusions on the outer circumference thereof, and the second roller is a paper discharge roller which discharges the recording medium after the printing process.
